(19) United States
(12) Patent Application Publication
(10) Pub. No.: US 2018/0189752 A1
(43) Pub. Date: Jul. 5, 2018

(54) Money transfer using an encrypted text and new global virtual currency system

(71) Applicant: Said Benjebli, Everett, MA (US)

(72) Inventor: Said Benjebli, Everett, MA (US)

(21) Appl. No.: 15/394,811

(22) Filed: Dec. 30, 2016

(51) Int. Cl. G06Q 20/06; G06Q 20/38

(52) U.S. Cl. CPC G06Q 20/065; G06Q 2220/00; G06Q 20/382

(57) ABSTRACT

A money transfer using an encrypted text and new global virtual currency system, the present invention is a new method and system to make the payment and TelePayment easier even if there is no internet connection between the sender and the receiver and without any 3rd party so that the money transferring action will be secured without any party see its details, the money transfer method of the present invention use a high level of encryption to make the money transfer process more secure than the other ways, the present invention provide a new global virtual currency.

### CROSS-REFERENCE TO RELATED APPLICATIONS

The present application relates and claims priority to U.S. provisional patent application No. 62/272,084 filed on Dec. 29, 2015.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates to a system and method of payment transaction, and more particularly to an offline payment transaction using global virtual currency system.

### Description of the Related Art

There are a lot of money transfer ways and methods depends on sending and receiving money online, it is required in these traditional ways to send and receive money to have internet network so the money can be transferred, if the sender, receiver or both of them have not an internet connection so there is no way to send the money, also many of the money transfer ways managed by a 3rd party, means that all the money transaction will be monitored and disclosed to this 3rd party.

The present invention provide the solution for this problem, the present invention is a money transfer method based on code, the present invention is a new method and system to make the payment and TelePayment easier even if there is no internet connection between the sender and the receiver and without any 3rd party so that the money transferring action will be secured without any party see its details.

The present method and system to make the payment and TelePayment using a cross platform software, exchanging a short encrypted special Key (text of 10 Nbrs or/and letters (more/less), that can recognised just by the target device, using a digital telecommunication or traditional communication way (With or without any electronic network) exchanging a global virtual currency.

U.S. patent application No. 62/074,019 by Hu; Chin-hao; Hsu; Pai-tsung discloses OFFLINE VIRTUAL CURRENCY TRANSACTION but fails to provide means to allow users the ability to secure their transactions because users will disclose their transactions to a third party.

### BRIEF SUMMARY OF THE INVENTION

In one aspect the present invention is a new method and system to make the payment and TelePayment easier even if there is no internet connection between the sender and the receiver and without any 3rd party so that the money transfer action will be secured without any part see its details.

In another aspect the present invention is a method and system to make the payment and TelePayment using a cross platform software, exchanging a short encrypted special Key (text of 10 Nbrs or/and letters (more/less), that can recognised just by the target device, using a digital telecommunication or traditional communication way (With or without any electronic network) exchanging a global virtual currency.

### DESCRIPTION OF THE DRAWINGS

For a more complete understanding of the present invention, reference is now made to the following descriptions:

FIG. 1 the idea of the invention in general and the framework of the invention.

FIG. 2 entities and authorities virtual currency cosmic.

FIG. 3 the screen of the software where user will activate the software.

FIG. 4 the main screen of the software where a user can choose between receive money, send money, sell or shop.

FIG. 5 the sender screen.

FIG. 6 the beneficiary screen.

FIG. 7 the user record database tables.

FIG. 8 the cloud (servers) record database tables.

FIG. 9 closed secret encryption process.

FIG. 10 the activation process for a copy on a device.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The idea of the invention:

The present invention is a new payment method and system to make the money payment and transfer easier without disclose the money transaction to any third party. The present invention is a transfer and payment method using a cross platform software, exchanging a short encrypted special Key (text of 10 numbers or/and letters, more/less), that can recognised just by the target device, using a digital telecommunication or traditional communication way (With or without any electronic network) exchanging a global virtual currency. The system uses an Algorithm can be programmed using any language achieved the desired purpose and must provide secured closed source code. The Encryption mechanism adopted by the system is based on the use of several levels of encryption and the use of multiple keys, and included all of that in the source code system for the copy of both parties. Both of them codes of encryption and the keys in many levels are included In the closed code source on the system. (one both sides of the transaction: same closed code (each copy of the App), not just one.

The system consists of the following components:

1—A process of making Payment and Telepayment (money Transfer) between “Two Parties” without any 3rd party.

2—new method to do the Telepayment without internet using the TargetID made public Key.

3—The concept of Distribution the unique international identifiers for the system users.

4—A method to Protect the system user's identity.

5—New targeting method based on using user's financial profiles and Money Habits and their transactions informations to provide their content and informations and goods that fit their style and their needs without identifying their true identity.

6—Global Virtual Currency Concept.

7—The Concept of a Decentralised Creation of Virtual money process and System.

8—A method to give, Increase and protect the Value of the global virtual currency.

9—The design of the software.

10—New Encryption Multi-Levels multi-keys integrated method.

11—New method to exchange Encrypted Information using a TargetID-made Public Key.

The idea of the invention in general and the framework of the invention:

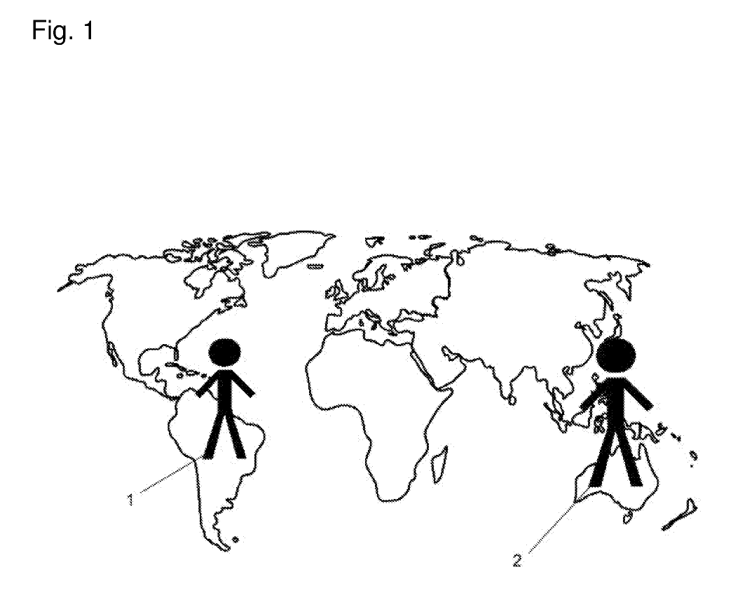

Referring to FIG. 1 the telepayment (money exchange) system is doing between two parties from anywhere in the world, the sender 1 and the beneficiary 2, by sending a short message from the sender to the receiver, has generated by a software system, using a secret algorithm based on a special secret encryption method. That convert the critical informations of the transaction to a public special target made ID key of 10 digit (less or more—numbers or/and letters) that can be understood and used just by the device of the right Beneficiary (target). The process of converting money taking place between the two parties that are the sender and the receiver without the presence of any intermediary party.

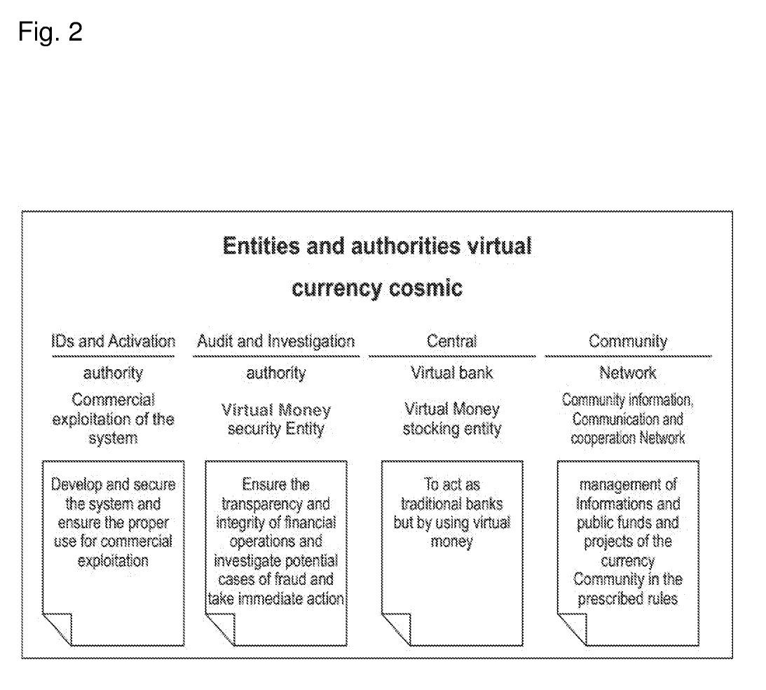

Referring to FIG. 2 the system is based on a private virtual currency, as shown in FIG. 2 there are four entities and authorities involved in the matter of the virtual currency:
IDs and activation authority (Commercial exploitation of the system), this authority will develop and secure the system and ensure the proper use for commercial exploitation.
Audit and Investigation authority (Virtual Money security Entity), this authority to ensure the transparency and integrity of financial operations and investigate potential cases of fraud and take immediate action.
Central Virtual bank (Virtual Money stocking entity), it is to act as traditional banks but by using virtual money not traditional money.
Community network (Community information, Communication and cooperation Network), it is for the management of Informations and public funds and projects of the currency community in the prescribed rules.

The accounts are not bound by traditional banks or money transfer agencies. The global virtual currency is subject to a transparent regulation has the agreement by all the users of the currency. Creation of money due exclusively by the individual person. The audit and investigation body (authority) hold any new money until get an order from the community authority. When the user release his money he must to authorize to put a half of his money as deposit in the global virtual bank and give the community a half of his money for the Development and International Cooperation Fund. The Development and International Cooperation Fund will use this money to promote the system and the currency and work for the good of the humanity. Just individual people have a legal responsibility (18+) can release the same share of currency for everybody on the earth.

How the present invention work:

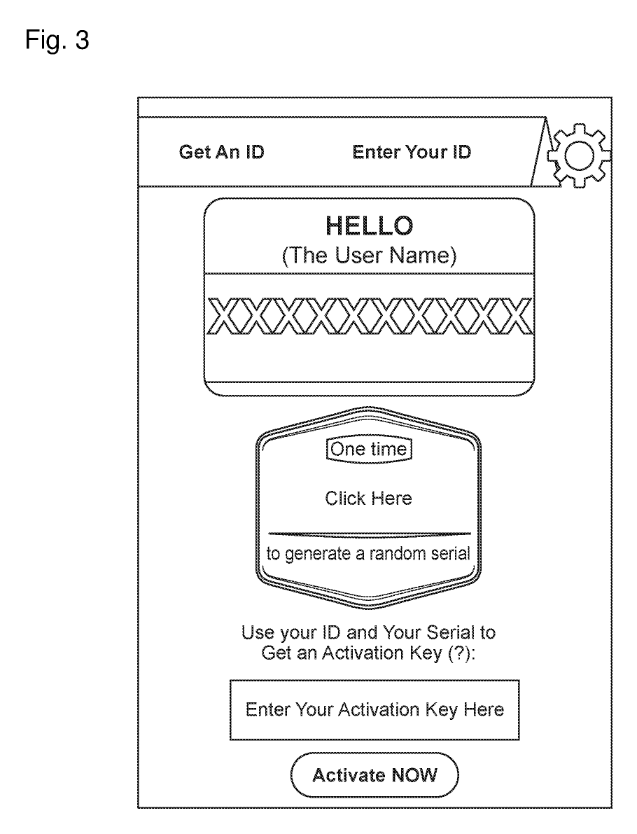

Referring to FIG. 3 this is the first screen after user install the app on his mobile where he can ask the system to give him an ID because each legal person wants to use the system should receive a single global identifier as a number (Or Letters) of 10 digits for each device, or enter his ID if he already have one, on this screen the user will see his username and he will generate a random serial so he can use his ID and Your Serial number to get an Activation Key then he will enter his activation key then click activate now to activate his account.

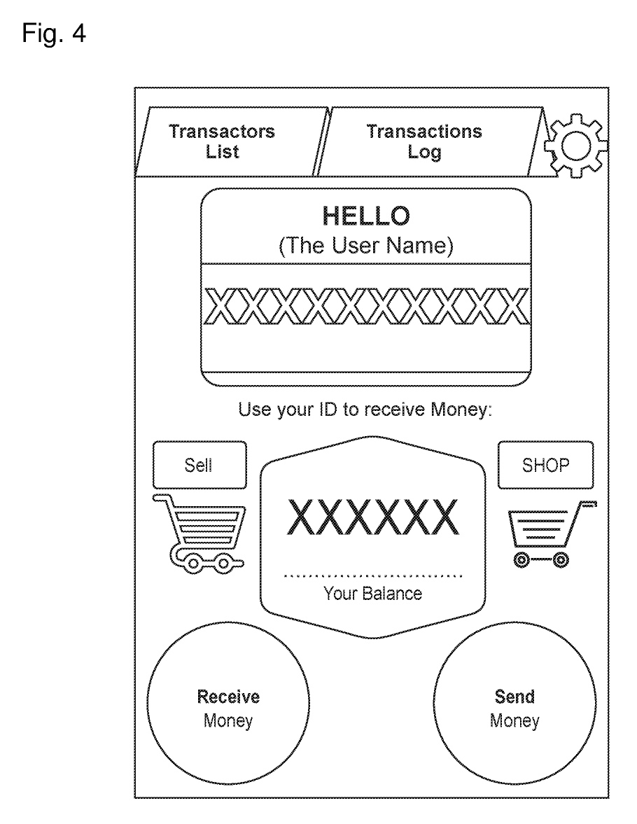

Referring to FIG. 4 this is the main screen of the software where a user can see the transaction list, transaction log and his ID to use it when want to receive money by sending the ID to the sender, also the user can choose between receive money, send money, sell or shop.

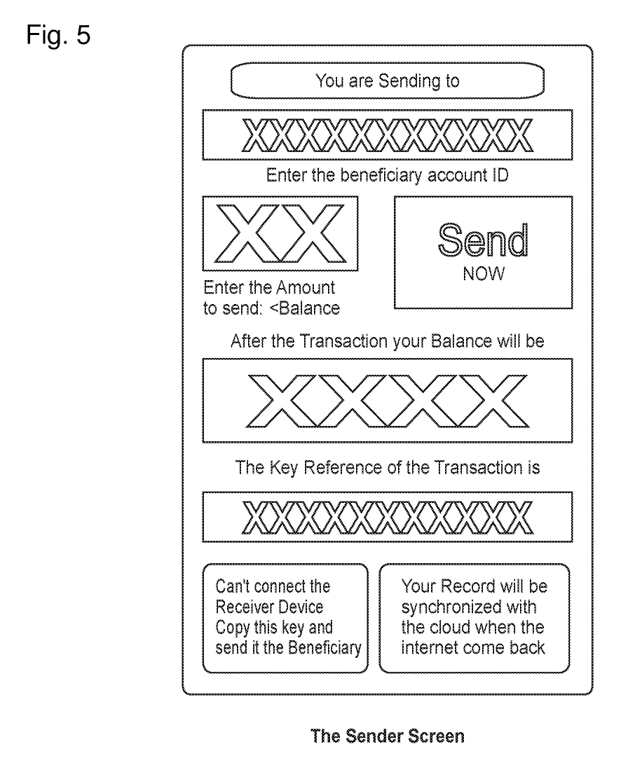

Referring to FIG. 5 when a user want to send money to a beneficiary he do 2 easy steps:
Provide the receiver (Target) (beneficiary) ID.
Provide the amount desired to send (Less than the Balance) and the system will generate an encrypted Special Key for the transaction.

In the sender screen the system will ask the sender to enter the account ID of the beneficiary then the sender will enter the amount he want to send to the beneficiary and before the sender will click send now the system will tell him his balance after the transaction then the system will tell the user the Key Reference of the Transaction then the sender will tell the user he can copy this key and send it the Beneficiary if he can't connect the Receiver Device, finally the system will mention that the user record will be synchronized with the cloud when the internet come back.

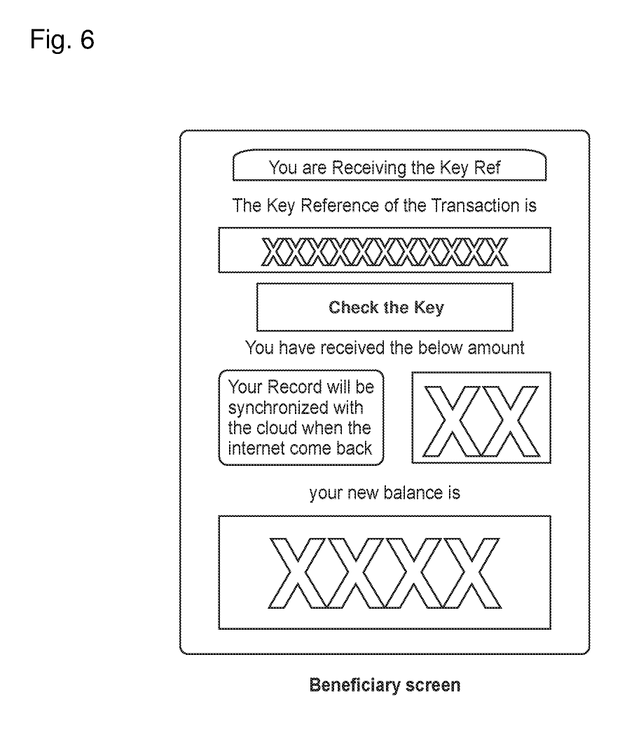

Referring to FIG. 6 the beneficiary screen where the system mention to the user that he/she is Receiving the Key Ref and ask to check the key ref then the system will mention to the user the amount he received then the system will mention that the record will be synchronized with the cloud when the internet come back.

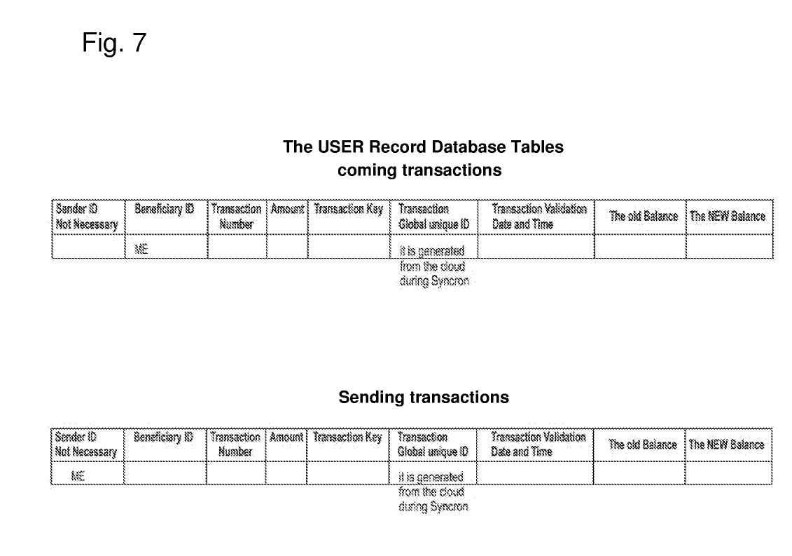

Referring to FIG. 7, this is the user record database tables, the user can see these tables on his account to check all the coming and sending transactions as shown in FIG. 7 as the following:
The coming transactions table where we can see the sender ID, beneficiary ID, transaction number, amount, transaction key, transaction global unique ID that is generated from the cloud during syncron, transaction validation date and time, the old balance and the new balance.
The sending transaction table where we can see the sender ID, beneficiary ID, transaction number, amount, transaction key, transaction global unique ID that is generated from the cloud during syncron, transaction validation date and time, the old balance and the new balance.

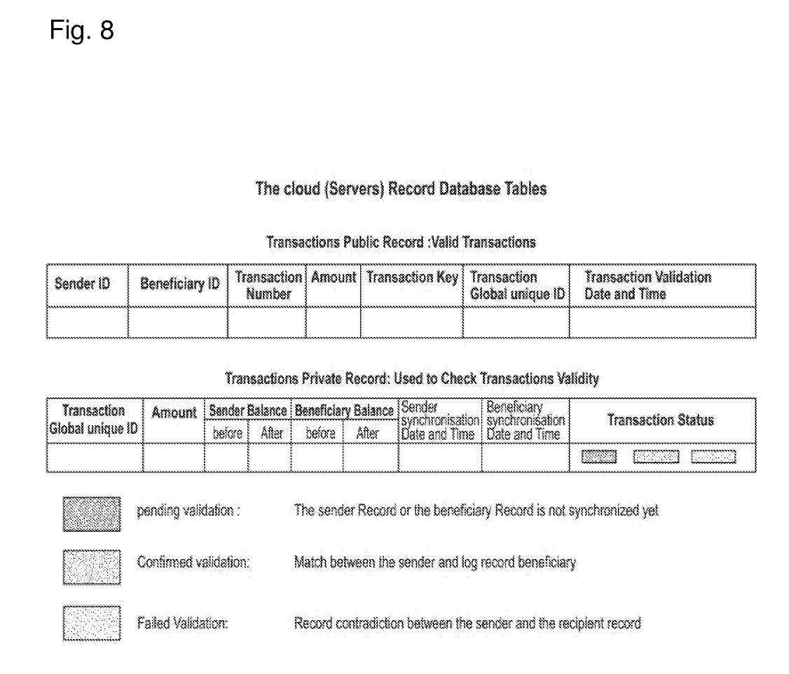

Referring to FIG. 8, this is the cloud (servers) record database tables, these tables can be checked by the system operator, the system operator can see these tables to check the transactions public record of the valid transactions and the transactions private record or table used to check transactions validity, in the following we will explain more about these two tables or records:
Transactions public record of the Valid Transactions, in this record or table we can see sender ID, beneficiary ID, transaction number, amount, transaction key, Transaction, global unique ID and the transaction validation date and time.
Transactions private record or table used to check transactions validity, in this record we can see the transaction global unique ID, amount, sender balance (before and after the transaction) beneficiary balance (before and after the transaction), sender synchronisation date and time, beneficiary synchronisation date and time, and transaction status that may be one of the following:
   Pending validation where the sender record or the beneficiary record is not synchronized yet.
   Confirmed validation if there is a match between the sender and log record beneficiary.
   Failed Validation if there is a record contradiction between the sender and the recipient record.

As shown in FIG. 7 and FIG. 8, all the important transaction informations is encrypted to one Key of 10 digits, the Public Special encrypted Key can be sent to the receiver by the internet or by phone or by traditional message (voice—letter—telegram—writing on the wall), this key tell the target side (Receiver) about the methods used in the encryption phase (multilayer/Multilevel) and the right decryption key(S) for every layer (level) and method. When the sender authorizes any transaction, the system will take off the amount out of from the sender balance, if the balance smaller than the amount the transaction can not made. Then the system give the transaction a unique number, and the system save the amount the transaction number, and any critical information, and use a secret algorithm to generate one or more validation codes related to this unique informations, than the system put the brut informations and the validation code(s) together in one text message, then the system take the receiver ID as reference for the transaction and use different traditional encryption method to generate an encrypted message that can be understood just by the beneficiary device that is related to this ID, then it pass it in many levels of traditional encryption methods process, using the receiver (target) as Key of Keys for this encryption operation. And the encrypted message will be send to the receiver and be shared on the public Record Servers (Clouds). The cloud saves all keys and the both record versions of the two part of any transaction, and any third party can track the balance of any user and his transactions and can recognise any fake transaction. The system can work independently without any need of the cloud, the cloud is just to track all transaction and show that for the public and make sure about the safety of the currency and the system. When the beneficiary enter this Special Key to his copy in the system, the system decrypts the Key and Extract the decrypted information and recognise the amount and some other critical information about the transaction including the validation code(s). The encrypted 10 digits keys can be sent to the receiver of the money (the target) using any mean possible (digital or not digital).

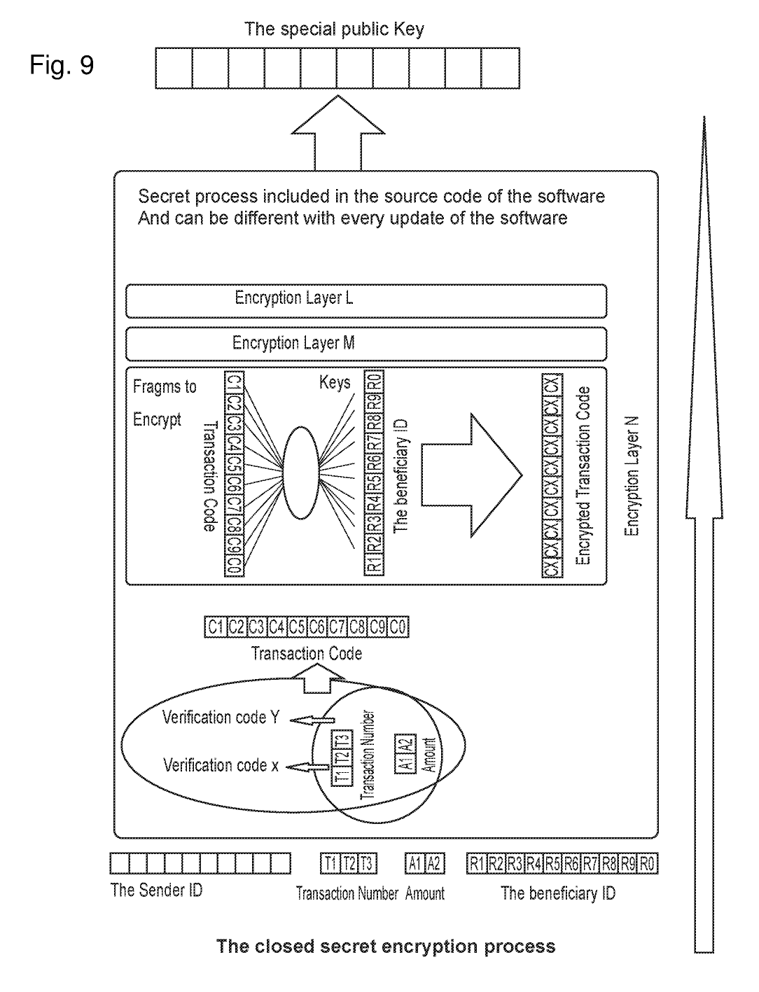

Referring to FIG. 9 this is the closed secret encryption process, the encrypted special key is useless and without any meaning for every user except the device of the right receiver (The Target). This encrypted key can be understood just by the right receiver device and be used only for one single time. The System generate for every transaction a unique one or more validation codes, this code(s) work as an internal mechanism allow the target device to verify the authenticity of any encrypted key was received, and that happened exactly after the extraction and the decryption of the received key and before converting this information as money in the balance of funds in the beneficiary party and put the transaction information in the local record. There are no risks to know the encrypted key by the public or know about the process.

The Server side (The Cloud) of the system use a traditional way to find fake money, the system comparate the two version of any transaction record and the change in the balance that has made during this transaction and mark any equal records as Valid Transaction, Missing record as pending transaction, and any contradiction as possible Fake Transaction. When the system observe any Possible Fake Transaction the authority of security and auditing put the two part of this transaction in the Hold List, and open a case for Investigation and publish the result for the public and advise the community to avoid any transaction with those devices, and any transaction will be made including someone in the hold list will be in the hold list and that work automatically.

This system to transfer money between two different parts without anyone between them by exchanging chain of letters or numbers, this system can work by letters and numbers combined or separate but using numbers make it more effective because numbers have global uses. Its function by sending an encrypted short chain or letters or number to the receiver of money, the system used different methods of encryption classified in many level combined with many keys. Both methods include symmetric encryption and fragmentation and some kind of traditional encryption including multiplication and dividing. The system used some parts of the receiver ID as Keys Key so no one can decrypt the chain except the device of the receiver.

The first step of encryption is its max fragmentation, the second step of encryption is its min defragmentation (reconsition). In a specific level of encryption we divide the chain to two different parts, the first is many statics informations and the second is dynamic. The system use the relation between the static parts and the dynamics parts of the chain to verified it. The system use this verification as the last important check of the other identification of the chain. It is a self verification so there is no needs to check the code by an exterior.

In the normal case there is no need for an exterior verification, but because of the nature of the high technology and the fact that some hackers can always crack any system. we need a backup as a an exterior verificator to register and publish all transaction made by any device using the system. The system required that every User Id should be unique to keep the possibility of tracking all transaction for every device.

To organise the process of id distribution the system required the existence of an authority for that, and any device require a pin number that must be given by this authority using a similar methods of encryption that used to generate the chain of transaction (Not the exact same).

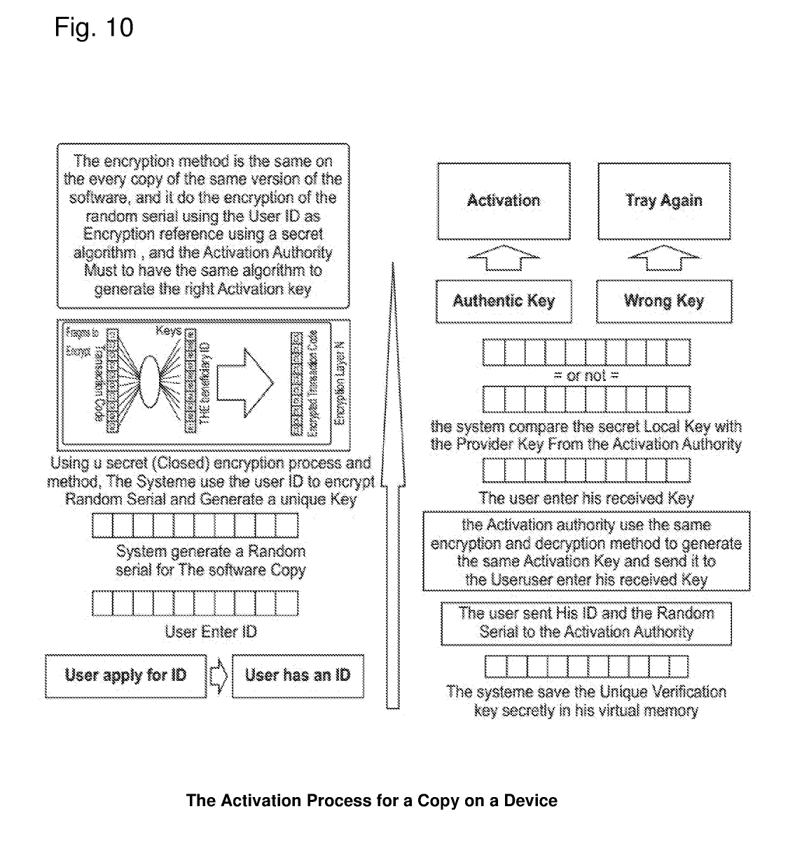

Referring to FIG. 10 this is the activation process for a copy of the software or app on a device, each physical or legal person wants to use the system should receive a single global identifier as a number (Or Letters) of 10 digits for each device, the system is installed on (each copy of the system). The IDs distribution process managed by an authority that must work together and under supervision of the authority of audit and Investigation. The user selects ID number desired unless if it was reserved by another user, or by companies that purchase and sale premium unique identifiers. The Access to an international ID does not require any personal private information about the user or push him to expose his personal identity of his device (machine) identity to get an Id for his copy of the software (the system) unless if he volunteer to provide this kind of information. The authority of ID distribution should not require or expose any personal information about users except in case of possible fraud open investigation. To be activated and able to send and receive money. The system require activation after the download and the installation. The Activation process start by entering the user Id or take him to the link to get a new Unique Available ID, then the system generate a random 10 digit serial for the installed copy, then wait for the activation Key. The Audit and Investigation authority must know about the algorithm that can generate the activation key for this specific installation (copy) of the software. Than the Id get shown on the local and public record with 00 balance.

1. A method for offline money transfer without a third party using an encrypted text and new global virtual currency system.

2. The method of claim 1, wherein the money transfer system is offline without disclosing the money transactions to any third party, the system is doing the transaction between two parties from anywhere in the world, the sender and the beneficiary, by sending an encrypted short message from the sender to the receiver, the message has generated by a software system, when the receiver enter the special key included in the message to his copy in the system, the system decrypts the key and extract the decrypted information and recognise the amount and the critical information about the transaction including the validation code(s), the encrypted key can be sent to the receiver of the money (the target) using any mean possible (digital or not digital), the process of transferring money between the two parties that are the sender and the receiver is without the presence of any intermediary party.

3. The method of claim 1, wherein the system using a secret algorithm based on a special secret encryption method, that convert the critical informations of the transaction to a public special target made ID key of 10 digit (less or more—numbers or/and letters) that can be understood and used just by the device of the right Beneficiary (target), an encryption Multi-Levels multi-keys integrated method to protect all money transactions and a method to exchange encrypted information using a targetID-made public key, the public special encrypted Key can be sent to the receiver by the internet, by phone or by traditional message (voice—letter—telegram—writing), this key tell the target side (receiver) about the methods used in the encryption phase (multilayer/Multilevel) and the right decryption key(S) for every layer (level) and method.

4. The method of claim 1, wherein there is a concept of a decentralised creation of virtual money process and system, and a method to give, Increase and protect the value of the global virtual currency.
